(19) United States
(12) Patent Application Publication
(10) Pub. No.: US 2025/0187389 A1
(43) Pub. Date: Jun. 12, 2025

(54) VEHICLE THERMAL MANAGEMENT SYSTEM

(71) Applicants: HYUNDAI MOTOR COMPANY, Seoul (KR); KIA CORPORATION, Seoul (KR)

(72) Inventors: Jae Yeon Moon, Seoul (KR); Seong Bin Jeong, Seongnam-si (KR); Dong Ju Ko, Hwaseong-si (KR); Chang Gi Ryu, Seoul (KR); Won Bin Jeong, Hwaseong-si (KR)

(73) Assignees: HYUNDAI MOTOR COMPANY, Seoul (KR); KIA CORPORATION, Seoul (KR)

(21) Appl. No.: 18/678,019

(22) Filed: May 30, 2024

(30) Foreign Application Priority Data
Dec. 6, 2023 (KR) 10-2023-0176011

(51) Int. Cl. B60H 1/00

(52) U.S. Cl. CPC B60H 1/00278; B60H 1/00485; B60H 1/00821

(57) ABSTRACT

A vehicle thermal management system includes: a control valve; a battery fluidly connected to the control valve; a power electronics (PE) component fluidly connected to the control valve; a radiator fluidly connected to the control valve; and a high-performance computer (HPC) fluidly connected to the control valve. In particular, the HPC and the battery are connected in parallel to the control valve, and the control valve is configured to control the flow of a coolant between the PE component, the radiator, the battery, and the HPC.

### CROSS-REFERENCE TO RELATED APPLICATION

This application claims the benefit of and priority to Korean Patent Application No. 10-2023-0176011, filed on Dec. 6, 2023, in the Korean Intellectual Property Office, the disclosure of which is incorporated herein in its entirety by reference.

### TECHNICAL FIELD

The present disclosure relates to a vehicle thermal management system, and more particularly, to a vehicle thermal management system designed to efficiently perform thermal management of a battery, a power electronics (PE) component, a high-performance computer, and the like.

### BACKGROUND

With a growing interest: n energy efficiency and environmental issues, eco-friendly vehicles that can replace internal combustion engine vehicles have been developed. Such eco-friendly vehicles are classified into electric vehicles which are driven using fuel cells or electricity as a power source and hybrid vehicles which are driven using an engine and a battery.

Electric vehicles or hybrid vehicles may include a vehicle thermal management system for heating, ventilation, and air conditioning (HVAC) in a cabin (or passenger compartment). The vehicle thermal management system also maintains a battery and a power electronics (PE) component at optimal temperatures. The vehicle thermal management system may include a refrigerant system for HVAC in the cabin, and a coolant system for maintaining the battery and the PE component at appropriate temperatures.

The refrigerant system may be designed to perform the heating and cooling of the cabin using phase changes of a refrigerant circulating through a compressor, a condenser, an expansion valve, and an evaporator. The refrigerant system may be thermally connected to the coolant system through various heat exchangers and/or chillers.

Meanwhile, the vehicle may include a high-performance computer (HPC) for various functions and data processing. For example, the HPC may be an autonomous driving controller that recognizes information such as road and traffic conditions and coordinates, determines an optimal route, and performs actual control of the vehicle. A heat generating amount of the HPC may be relatively high, and accordingly it is desired to properly cool the HPC.

In the vehicle thermal management system according to the related art, the HPC may be thermally connected to a cooling loop connected to the refrigerant system, and be cooled using a refrigerant circulated by the compressor. As the cooling loop for cooling the HPC is connected to the refrigerant system, the configuration of the vehicle thermal management system may become relatively complex, and thus the manufacturing cost and weight of the vehicle thermal management system may be relatively increased. In particular, the HPC cannot be cooled in an operating mode in which the compressor of the refrigerant system does not operate, making it unable to drive the vehicle.

To solve the above-described problems of the related art vehicle thermal management system, the following vehicle thermal management system has been suggested: the HPC is not thermally connected to the refrigerant system, but the HPC is connected in series to the battery of the coolant system. However, as the battery and the HPC are connected in series, thermal management of the battery and thermal management of the HPC may not be efficiently performed. Specifically, since a target temperature of the HPC for the thermal management of the HPC and a target temperature of the battery for the thermal management of the battery are different from each other, the thermal management of the HPC and the thermal management of the battery may not be efficiently performed. For example, when the HPC is cooled, the temperature of the battery may relatively increase, and accordingly the chiller may operate unnecessarily. When the battery is cooled, the HPC may be maintained at excessively low temperature. When the cooling of the HPC and the warming-up of the battery are required simultaneously, the warming-up of the battery may not be normally performed. When the refrigerant system operates in a heating mode, the cooling of the HPC and the warming-up of the battery may be required simultaneously, and accordingly the chiller and a battery warmer may operate unnecessarily.

The above information described in this background section is provided to assist in understanding the background of the inventive concept, and may include any technical concept which is not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a vehicle thermal management system designed to efficiently perform thermal management of a high-performance computer, thermal management of a battery, thermal management of a power electronics (PE) component, heating of a refrigerant system, and the like.

According to an aspect of the present disclosure, a vehicle thermal management system may include: a control valve; a battery fluidly connected to the control valve; a PE component fluidly connected to the control valve; and a radiator fluidly connected to the control valve. The vehicle thermal management system may further include a high-performance computer (HPC) fluidly connected to the control valve. The HPC and the battery may be connected in parallel to the control valve, and the control valve may be configured to control the flow of a coolant between the PE component, the radiator, the battery, and the HPC.

The control valve may include: a first port fluidly communicating with an inlet of the battery and an inlet of the HPC, and a second port fluidly communicating with an inlet of the PE component. The control valve may further include: a third port fluidly communicating with an inlet of the radiator, and a fourth port fluidly communicating with an outlet of the battery and an outlet of the HPC.

The vehicle thermal management system may further include a chiller thermally connected to a refrigerant system. The control valve may further include a fifth port communicating with the chiller.

The battery and the HPC may be connected in parallel to the chiller.

The radiator and the PE component may be connected in parallel to the chiller.

The control valve may be configured to fluidly connect the first port to at least one of the third port, the fourth port, and the fifth port.

The control valve may be configured to fluidly connect the second port to at least one of the third port, the fourth port, and the fifth port.

The chiller may include a refrigerant passage through which a refrigerant passes and a coolant passage through which the coolant passes. The chiller may further include a first port, a second port, and a third port communicating with the coolant passage.

The chiller may include: a first port communicating with the outlet of the battery and the outlet of the HPC, a second port communicating with an outlet of the PE component and an outlet of the radiator, and a third port fluidly communicating with the fifth port of the control valve.

The vehicle thermal management system may further include a distribution valve configured to control the flow of the coolant into at least one of the battery and the HPC.

The distribution valve may include an inlet port fluidly communicating with the first port of the control valve, a first outlet port fluidly communicating with the inlet of the battery, and a second outlet port fluidly communicating with the inlet of the HPC.

The vehicle thermal management system may further include a first pump fluidly communicating with the first port of the control valve.

The vehicle thermal management system may further include a second pump fluidly communicating with the second port of the control valve.

The vehicle thermal management system may further include a battery warmer fluidly connected to the battery.

The vehicle thermal management system may further include a reservoir tank fluidly connected to the radiator.

### BRIEF DESCRIPTION OF THE DRAWINGS

The above and other objects, features and advantages of the present disclosure should be more apparent from the following detailed description taken in conjunction with the accompanying drawings:

FIG. 1 illustrates a vehicle thermal management system according to an embodiment of the present disclosure;

FIG. 2 illustrates a state in which a vehicle thermal management system according to an embodiment of the present disclosure operates in a first mode;

FIG. 3 illustrates a state in which a vehicle thermal management system according to an embodiment of the present disclosure operates in a second mode;

FIG. 4 illustrates a state in which a vehicle thermal management system according to an embodiment of the present disclosure operates in a third mode;

FIG. 5 illustrates a state in which a vehicle thermal management system according to an embodiment of the present disclosure operates in a fourth mode;

FIG. 6 illustrates a state in which a vehicle thermal management system according to an embodiment of the present disclosure operates in a fifth mode; and

FIG. 7 illustrates a state in which a vehicle thermal management system according to an embodiment of the present disclosure operates in a sixth mode.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure is ruled out in order not to unnecessarily obscure the gist of the present disclosure.

Terms such as first, second, A, B, (a), and (b) may be used to describe the elements in embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

When a component, device, element, or the like of the present disclosure is described as having a purpose or performing an operation, function, or the like, the component, device, or element should be considered herein as being “configured to” meet that purpose or to perform that operation or function.

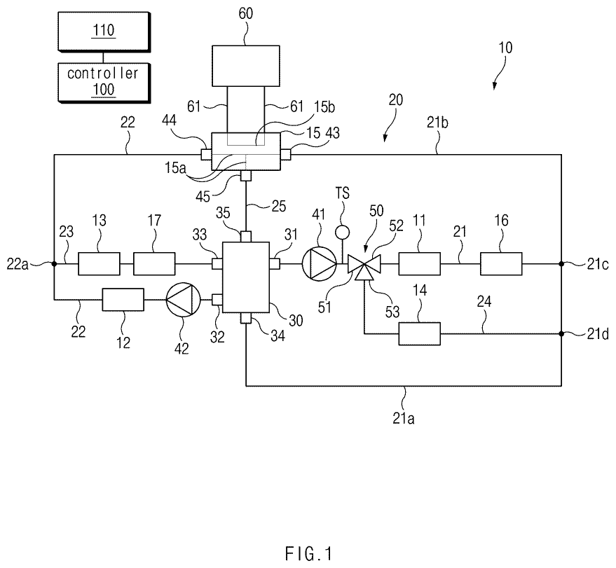

Referring to FIG. 1, a vehicle thermal management system according to an embodiment of the present disclosure may include a battery 11, a power electronics (PE) component 12, a radiator 13, a high-performance computer (HPC) 14, a chiller 15, and a coolant system 10 including a control valve 30.

The battery 11 may have a coolant passage provided inside or outside thereof. As a coolant passes through the coolant passage of the battery 11, the coolant may be heated or cooled, and the battery 11 may be maintained at an appropriate temperature. For example, the battery 11 may be a high-voltage battery pack of an electric vehicle.

The PE component 12 may have a coolant passage provided inside or outside thereof. As the coolant passes through the coolant passage of the PE component 12, the coolant may be heated or cooled, and the PE component 12 may be maintained at an appropriate temperature. For example, the PE component 12 may be an electric motor, an inverter, and the like, which are driving sources of an electric vehicle.

The radiator 13 may be disposed adjacent to a front grille of the vehicle, and the radiator 13 may have a coolant passage provided therein. The coolant passing through the coolant passage of the radiator 13 may be cooled by ambient air passing by an exterior surface of the radiator 13. The radiator 13 may cool the coolant using the ambient air forcibly blown by a cooling fan (not shown).

The HPC 14 may have a coolant passage provided inside or outside thereof. As the coolant passes through the coolant passage of the HPC 14, the coolant may be heated or cooled, and the HPC 14 may be maintained at an appropriate temperature. The HPC 14 may be provided to perform various functions and data processing. According to an embodiment, the HPC 14 may be an autonomous driving controller that recognizes information such as road and traffic conditions and coordinates, determines an optimal route, and performs actual control of the vehicle.

The chiller 15 may be configured to be thermally connected to a refrigerant system 60 and a coolant system 10. In other words, the chiller 15 may be configured to transfer heat between the coolant circulating in the coolant system 10 and a refrigerant circulating in the refrigerant system 60. The chiller 15 may include a coolant passage 15a through which the coolant passes, and a refrigerant passage 15b through which the refrigerant passes. The refrigerant passage 15b of the chiller 15 may be fluidly connected to a refrigerant line 61 of the refrigerant system 60. The refrigerant system 60 may include a compressor, a condenser, an expansion valve, and an evaporator.

The control valve 30 may include: a first port 31 fluidly communicating with an inlet of the coolant passage of the battery 11 and an inlet of the coolant passage of the HPC 14, and a second port 32 fluidly communicating with an inlet of the coolant passage of the PE component 12. The control valve 30 may further include: a third port 33 fluidly communicating with an inlet of the coolant passage of the radiator 13, a fourth port 34 fluidly communicating with an outlet of the coolant passage of the battery 11 and an outlet of the coolant passage of the HPC 14, and a fifth port 35 fluidly communicating with the coolant passage 15a of the chiller 15.

The chiller 15 may include a first port 43, a second port 44, and a third port 45 communicating with the coolant passage 15a. The first port 43 of the chiller 15 may fluidly communicate with the outlet of the coolant passage of the battery 11 and the outlet of the coolant passage of the HPC 14. The second port 44 of the chiller 15 may fluidly communicate with an outlet of the coolant passage of the PE component 12 and an outlet of the coolant passage of the radiator 13. The third port 45 of the chiller 15 may fluidly communicate with the fifth port 35 of the control valve 30.

The vehicle thermal management system according to an embodiment of the present disclosure may further include a distribution valve 50 configured to control the flow of the coolant in a manner that allows the coolant discharged from the first port 31 of the control valve 30 to be directed to at least one of the battery 11 and the HPC 14. The distribution valve 50 may be located at a point at which the coolant is distributed to the battery 11 and the HPC 14.

According to an embodiment, the distribution valve 50 may include an inlet port 51 fluidly communicating with the first port 31 of the control valve 30, a first outlet port 52 fluidly communicating with the inlet of the coolant passage of the battery 11, and a second outlet port 53 fluidly communicating with the inlet of the coolant passage of the HPC 14.

The vehicle thermal management system according to an embodiment of the present disclosure may further include a battery warmer 16 fluidly connected to the battery 11. The battery warmer 16 may have a coolant passage provided inside or outside thereof, and the coolant may pass through the coolant passage of the battery warmer 16. The coolant passage of the battery warmer 16 may be fluidly connected to the coolant passage of the battery 11, and the battery warmer 16 may be disposed on the upstream or downstream side of the battery 11 in a first coolant line 21 to be described below. According to the embodiment illustrated in FIG. 1, the battery warmer 16 may be disposed on the downstream side of the battery 11. For example, the battery warmer 16 may be an electric heater heating the coolant using electric energy. When the warming-up of the battery 11 is required, the battery warmer 16 may be turned on. As the battery warmer 16 is turned on, the coolant may be heated by the battery warmer 16. When the battery warmer 16 is turned off, the coolant may pass through the coolant passage of the battery warmer 16 without being heated by the battery warmer 16.

The vehicle thermal management system according to an embodiment of the present disclosure may further include a reservoir tank 17 fluidly communicating with the third port 33 of the control valve 30, and the reservoir tank 17 may be fluidly connected to the radiator 13. The reservoir tank 17 may be located on the downstream side of the radiator 13 in a third coolant line 23. The reservoir tank 17 may temporarily store the coolant. When a coolant pressure in the radiator 13 is increased to a predetermined threshold pressure or higher, the reservoir tank 17 may receive the coolant, or when the coolant pressure in the radiator 13 is lowered below the predetermined threshold pressure, the reservoir tank 17 may replenish the coolant.

The vehicle thermal management system according to an embodiment of the present disclosure may include a first pump 41 fluidly communicating with the first port 31 of the control valve 30. The first pump 41 may be located between the first port 31 of the control valve 30 and the inlet port 51 of the distribution valve 50, and accordingly the first pump 41 may be located on the upstream side of the coolant passage of the battery 11 and the coolant passage of the HPC 14. The first pump 41 may be configured to pump the coolant discharged from the first port 31 of the control valve 30 toward the distribution valve 50.

The vehicle thermal management system according to an embodiment of the present disclosure may further include a coolant temperature sensor TS disposed on the downstream side of the first pump 41, and the coolant temperature sensor TS may be configured to sense the temperature of the coolant discharged from the first pump 41.

The vehicle thermal management system according to an embodiment of the present disclosure may include a second pump 42 fluidly communicating with the second port 32 of the control valve 30. The second pump 42 may be located between the PE component 12 and the second port 32 of the control valve 30, and the second pump 42 may be located on the upstream side of the coolant passage of the PE component 12. The second pump 42 may be configured to pump the coolant discharged from the second port 32 of the control valve 30 toward the PE component 12.

According to an embodiment of the present disclosure, the control valve 30 may be configured to fluidly connect the first port 31 to at least one of the third port 33, the fourth port 34, and the fifth port 35 under control of a controller 100.

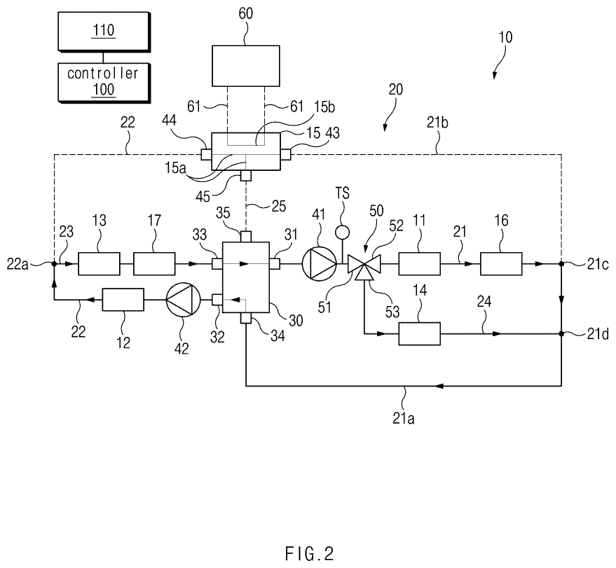

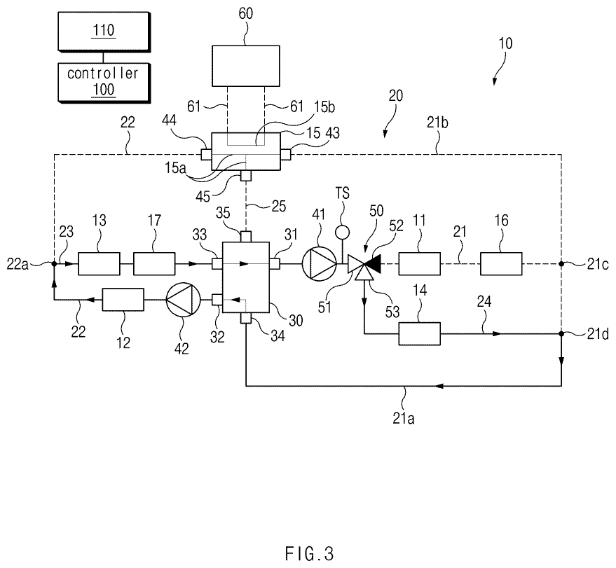

As illustrated in FIGS. 2 and 3, when the control valve 30 fluidly connects the first port 31 and the third port 33 by the controller 100, the coolant cooled by the radiator 13 may pass through the coolant passage of the battery 11 and/or the coolant passage of the HPC 14 by the first pump 41. Accordingly, the coolant cooled by the radiator 13 may cool the battery 11 and/or the HPC 14.

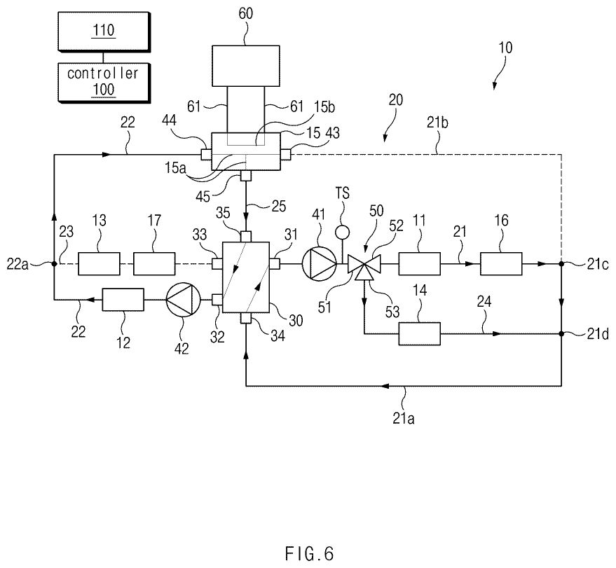

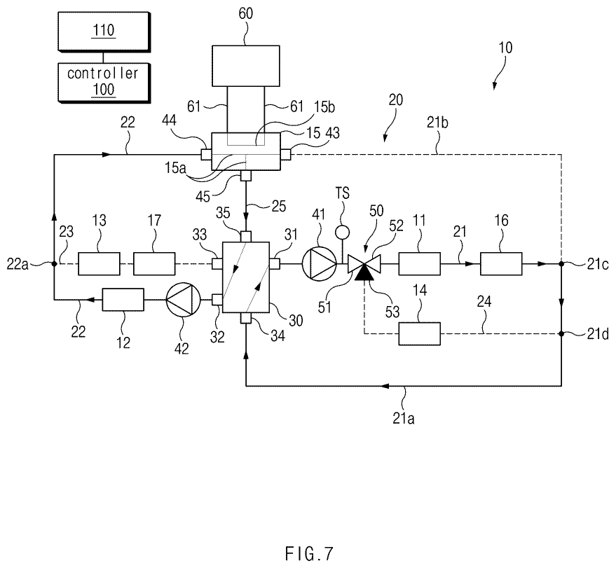

As illustrated in FIGS. 6 and 7, when the control valve 30 fluidly connects the first port 31 and the fourth port 34 by the controller 100, the coolant discharged from the first port 31 may pass through the coolant passage of the battery 11 and/or the coolant passage of the HPC 14 by the first pump 41, and the coolant discharged from the coolant passage of the battery 11 and/or the coolant passage of the HPC 14 may be directed into an inlet of the first pump 41 through the fourth port 34 and the first port 31. Accordingly, the battery 11 may be warmed up by waste heat of the HPC 14 or the battery warmer 16.

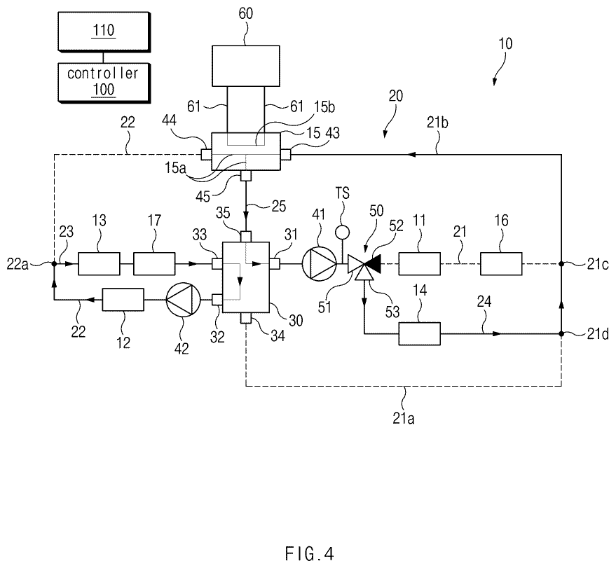

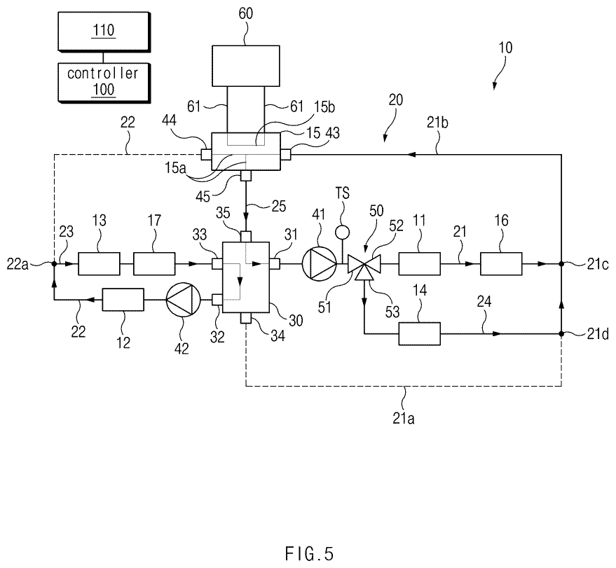

As illustrated in FIGS. 4 and 5, when the control valve 30 fluidly connects the first port 31 and the fifth port 35 by the controller 100, the coolant discharged from the first port 31 may pass through the coolant passage of the battery 11 and/or the coolant passage of the HPC 14 by the first pump 41, and the coolant discharged from the coolant passage of the battery 11 and/or the coolant passage of the HPC 14 may be directed into the inlet of the first pump 41 through the coolant passage 15a of the chiller 15, the fifth port 35, and the first port 31. Accordingly, the refrigerant system 60 may absorb the waste heat of the HPC 14 and/or waste heat of the battery 11 through the chiller 15 or the coolant cooled by the chiller 15 may cool the HPC 14 and/or the battery 11.

According to an embodiment of the present disclosure, the control valve 30 may be configured to fluidly connect the second port 32 to at least one of the third port 33, the fourth port 34, and the fifth port 35 under control of the controller 100.

As illustrated in FIGS. 4 and 5, when the control valve 30 fluidly connects the second port 32 and the third port 33 by the controller 100, the coolant discharged from the radiator 13 may be directed to the PE component 12 through the third port 33 and the second port 32 by the second pump 42. Accordingly, the coolant cooled by the radiator 13 may cool the PE component 12.

As illustrated in FIGS. 2 and 3, when the control valve 30 fluidly connects the second port 32 and the fourth port 34 by the controller 100, the coolant discharged from the battery 11 and/or the HPC 14 may be directed to the PE component 12 and the radiator 13 through the fourth port 34 and the second port 32 by the second pump 42. Accordingly, the coolant cooled by the radiator 13 may cool the PE component 12, the battery 11, and/or the HPC 14.

As illustrated in FIGS. 6 and 7, when the control valve 30 fluidly connects the second port 32 and the fifth port 35 by the controller 100, the coolant discharged from the second port 32 may pass through the PE component 12 and the coolant passage 15a of the chiller 15 by the second pump 42, and the coolant discharged from the coolant passage 15a of the chiller 15 may be directed to an inlet of the second pump 42 through the fifth port 35 and the second port 32. Accordingly, the refrigerant system 60 may absorb waste heat of the PE component 12 through the chiller 15 so that the refrigerant system 60 may operate in a heating mode.

According to an embodiment of the present disclosure, the distribution valve 50 may be configured to fluidly connect the inlet port 51 to the first outlet port 52 and/or the second outlet port 53 under control of the controller 100.

As illustrated in FIGS. 2, 5, and 6, when the distribution valve 50 fluidly connects the inlet port 51 to the first outlet port 52 and the second outlet port 53 by the controller 100, the coolant discharged from the first pump 41 may be directed to the coolant passage of the battery 11 and the coolant passage of the HPC 14. In particular, the distribution valve 50 may adjust a ratio between the opening degree of the first outlet port 52 and the opening degree of the second outlet port 53 based on the temperature of the coolant discharged from the first pump 41, thereby determining a ratio of the coolant distributed to the battery 11 and the HPC 14.

As illustrated in FIG. 7, when the distribution valve 50 fluidly connects the inlet port 51 to the first outlet port 52 and closes the second outlet port 53 by the controller 100, the coolant discharged from the first pump 41 may be directed to the coolant passage of the battery 11.

As illustrated in FIGS. 3 and 4, when the distribution valve 50 fluidly connects the inlet port 51 to the second outlet port 53 and closes the first outlet port 52 by the controller 100, the coolant discharged from the first pump 41 may be directed to the coolant passage of the HPC 14.

The coolant system 10 may include a coolant circulation path 20 allowing the coolant to circulate. The coolant circulation path 20 may include the first coolant line 21 extending from the first port 31 of the control valve 30, a first branch line 21a connecting a branch point 21c of the first coolant line 21 and the fourth port 34 of the control valve 30, and a second branch line 21b connecting the branch point 21c of the first coolant line 21 and the first port 43 of the chiller 15. The coolant circulation path 20 may further include: a second coolant line 22 connecting the second port 32 of the control valve 30 and the second port 44 of the chiller 15, a third coolant line 23 connecting the third port 33 of the control valve 30 and the second coolant line 22, a fourth coolant line 24 connected in parallel to the first coolant line 21, and a fifth coolant line connecting the fifth port 35 of the control valve 30 and the third port 45 of the chiller 15.

One end of the first coolant line 21 may be connected to the first port 31 of the control valve 30, and the other end of 25 the first coolant line 21 may be the branch point 21c. The first pump 41, the coolant passage of the battery 11, and the coolant passage of the battery warmer 16 may be fluidly connected to the first coolant line 21. The first pump 41 may be located on the upstream side of the coolant passage of the battery 11 in the first coolant line 21, and the battery warmer 16 may be located on the downstream side of the coolant passage of the battery 11 in the first coolant line 21. The first branch line 21a and the second branch line 21b may branch off from the branch point 21c of the first coolant line 21, and the branch point 21c may be located on the downstream side of the battery warmer 16. The first branch line 21a may connect the branch point 21c of the first coolant line 21 and the fourth port 34 of the control valve 30, and the second branch line 21b may connect the branch point 21c of the first coolant line 21 and the first port 43 of the chiller 15.

One end of the second coolant line 22 may be connected to the second port 32 of the control valve 30, and the other end of the second coolant line 22 may be connected to the second port 44 of the chiller 15. The second pump 42 and the coolant passage of the PE component 12 may be fluidly connected to the second coolant line 22.

One end of the third coolant line 23 may be connected to the third port 33 of the control valve 30, and the other end of the third coolant line 23 may be connected to a connection point 22a of the second coolant line 22. The coolant passage of the radiator 13 and the reservoir tank 17 may be fluidly connected to the third coolant line 23. Accordingly, the PE component 12 and the radiator 13 may be connected in parallel to the second port 44 of the chiller 15 through the second coolant line 22 and the third coolant line 23.

The fourth coolant line 24 may connect one point of the first coolant line 21 and the first branch line 21a. One end of the fourth coolant line 24 may be connected to the first coolant line 21 on the upstream side of the battery 11, and the other end of the fourth coolant line 24 may be connected to a connection point 21d of the first branch line 21a. The HPC 14 may be fluidly connected to the fourth coolant line 24. The distribution valve 50 may be disposed at a point to which the first coolant line 21 and the fourth coolant line 24 are connected. The first coolant line 21 and the fourth coolant line 24 may be connected in parallel to the first port 31 and the fourth port 34 of the control valve 30 through the first branch line 21a, and the first coolant line 21 and the fourth coolant line 24 may be connected in parallel to the first port 31 of the control valve 30 and the first port 43 of the chiller 15 through the second branch line 21b. Accordingly, the HPC 14 and the battery 11 may be connected in parallel to the control valve 30 and the chiller 15 through the first coolant line 21, the fourth coolant line 24, the first branch line 21a, and the second branch line 21b.

One end of the fifth coolant line 25 may be connected to the fifth port 35 of the control valve 30, and the other end of the fifth coolant line 25 may be connected to the third port 45 of the chiller 15.

The vehicle thermal management system according to an embodiment of the present disclosure may include a management system 110 configured to manage the battery 11 and the HPC 14. The management system 110 may transmit instructions for the cooling of the battery 11, the warming-up of the battery 11, and the cooling of the HPC 14 to the controller 100 so that the battery 11 and the HPC 14 may be maintained at appropriate temperatures.

According to an embodiment, the management system 110 may be an integrated management system configured to manage the battery 11 and the HPC 14 in an integrated manner. The integrated management system may be configured to monitor the states (temperature, current, voltage, etc.) of the battery 11 and the states (temperature, current, voltage, etc.) of the HPC 14, protect the battery 11 and the HPC 14 from electrical overload, predict the operational states of the battery 11 and the HPC 14, and continuously optimize the battery 11 and the HPC 14.

According to another embodiment, the management system 110 may include two stand-alone management systems separated into a battery management system for managing the battery 11 and an HPC management system for managing the HPC 14. The battery management system may be configured to monitor the states (temperature, current, voltage, etc.) of the battery 11, protect the battery 11 from electrical overload, predict the operational states of the battery 11, and continuously optimize the battery 11. The HPC management system may be configured to monitor the states (temperature, current, voltage, etc.) of the HPC 14, protect the HPC 14 from electrical overload, predict the operational states of the HPC 14, and continuously optimize the HPC 14.

The vehicle thermal management system according to an embodiment of the present disclosure may include the controller 100 controlling the control valve 30, the first pump 41, the second pump 42, the distribution valve 50, and the refrigerant system 60. The controller 100 may be configured to control the operations of the control valve 30, the first pump 41, the second pump 42, the distribution valve 50, and the refrigerant system 60 based on a maximum temperature of the battery 11 and a maximum temperature of the HPC 14 sensed by the management system 110, a temperature of the coolant sensed by the coolant temperature sensor TS, an ambient temperature of the vehicle sensed by an ambient temperature sensor of the vehicle, and the like.

FIG. 2 illustrates a state in which the vehicle thermal management system according to an embodiment of the present disclosure operates in a first mode. Referring to FIG. 2, when the vehicle thermal management system operates in the first mode, the coolant cooled by the radiator 13 may cool the battery 11, the HPC 14, and the PE component 12.

Referring to FIG. 2, the control valve 30 may fluidly connect the first port 31 and the third port 33, fluidly connect the second port 32 and the fourth port 34, and close the fifth port 35, and the distribution valve 50 may fluidly connect the inlet port 51 to the first outlet port 52 and the second outlet port 53 so that the coolant cooled by the radiator 13 may pass through the coolant passage of the battery 11, the coolant passage of the HPC 14, and the coolant passage of the PE component 12 by the first pump 41 and the second pump 42. The coolant discharged from the first port 31 of the control valve 30 may be distributed to the coolant passage of the battery 11 and the coolant passage of the HPC 14 through the first outlet port 52 and the second outlet port 53 of the distribution valve 50, and accordingly the coolant may cool the battery 11 and the HPC 14. Here, since the compressor of the refrigerant system 60 does not operate, heat exchange between the refrigerant and the coolant through the chiller 15 may not occur.

The vehicle thermal management system in the first mode may meet the following control conditions: the maximum temperature of the battery 11 is higher than a first required cooling temperature; the maximum temperature of the battery 11 is lower than a second required cooling temperature; the ambient temperature of the vehicle is lower than a first threshold ambient temperature; and the temperature of the coolant discharged from the first pump 41 is lower than the maximum temperature of the battery 11. The second required cooling temperature may be higher than the first required cooling temperature. For example, the first required cooling temperature may be 30° C., the second required cooling temperature may be 36° C., and the first threshold ambient temperature may be 25° C. As described above, the vehicle thermal management system in the first mode may allow the coolant to simultaneously cool the battery 11 and the HPC 14 through the radiator 13 in a state in which the compressor of the refrigerant system 60 does not operate so that the heat exchange between the refrigerant and the coolant through the chiller 15 may not occur, and thus HVAC power consumption of the refrigerant system 60 may be reduced.

FIG. 3 illustrates a state in which the vehicle thermal management system according to an embodiment of the present disclosure operates in a second mode. Referring to FIG. 3, when the vehicle thermal management system operates in the second mode, the coolant cooled by the radiator 13 may cool the HPC 14 and the PE component 12.

Referring to FIG. 3, the control valve 30 may fluidly connect the first port 31 and the third port 33, fluidly connect the second port 32 and the fourth port 34, and close the fifth port 35, and the distribution valve 50 may fluidly connect the inlet port 51 and the second outlet port 53 so that the coolant cooled by the radiator 13 may pass through the coolant passage of the HPC 14 and the coolant passage of the PE component 12 by the first pump 41 and the second pump 42. The coolant discharged from the first port 31 of the control valve 30 may be directed to the coolant passage of the HPC 14 through the second outlet port 53 of the distribution valve 50, and accordingly the coolant may cool the HPC 14. Here, since the compressor of the refrigerant system 60 does not operate, the heat exchange between the refrigerant and the coolant through the chiller 15 may not occur.

The vehicle thermal management system in the second mode may meet the following control conditions: the maximum temperature of the battery 11 is lower than the first required cooling temperature; the ambient temperature of the vehicle is lower than a second threshold ambient temperature; and the temperature of the coolant discharged from the first pump 41 is lower than a first threshold coolant temperature. For example, the first required cooling temperature may be 30° C., the second threshold ambient temperature may be 40° C., and the first threshold coolant temperature may be 45° C. As described above, the vehicle thermal management system in the second mode may allow the coolant to cool the HPC 14 through the radiator 13 in a state in which the compressor of the refrigerant system 60 does not operate so that the heat exchange between the refrigerant and the coolant through the chiller 15 may not occur, and thus HVAC power consumption of the refrigerant system 60 may be reduced.

FIG. 4 illustrates a state in which the vehicle thermal management system according to an embodiment of the present disclosure operates in a third mode. Referring to FIG. 4, when the vehicle thermal management system operates in the third mode, the coolant cooled by the radiator 13 may cool the PE component 12, and the refrigerant system 60 may operate in a heating mode using the waste heat of the HPC 14 or operate in a cooling mode to allow the coolant cooled by the chiller 15 to cool the HPC 14.

Referring to FIG. 4, the control valve 30 may fluidly connect the second port 32 and the third port 33 so that the coolant cooled by the radiator 13 may pass through the coolant passage of the PE component 12 by the second pump 42, and the PE component 12 may be cooled by the coolant.

Referring to FIG. 4, the control valve 30 may fluidly connect the first port 31 and the fifth port 35 and close the fourth port 34, and the distribution valve 50 may fluidly connect the inlet port 51 and the second outlet port 53 so that the coolant discharged from the first port 31 of the control valve 30 may pass through the coolant passage of the HPC 14 and the coolant passage 15a of the chiller 15 through the second outlet port 53 of the distribution valve 50.

When the heating of a cabin is required, the coolant heated by the waste heat of the HPC 14 may pass through the coolant passage 15a of the chiller 15, and the coolant passing through the coolant passage 15a of the chiller 15 may release heat to the refrigerant passing through the refrigerant passage 15b of the chiller 15 so that the refrigerant system 60 may absorb the waste heat of the HPC 14 through the chiller 15, and the refrigerant system 60 may operate in the heating mode.

When the cooling of the cabin is required, the refrigerant system 60 may operate in the cooling mode. As the refrigerant system 60 operates in the cooling mode, the coolant passing through the coolant passage 15a of the chiller 15 may release heat to the refrigerant passing through the refrigerant passage 15b of the chiller 15 so that the coolant may be cooled by the chiller 15, and the coolant cooled by the chiller 15 may cool the HPC 14.

The vehicle thermal management system in the third mode may meet the following control conditions (cooling conditions of the PE component 12 and the HPC 14): the maximum temperature of the battery 11 is lower than the second required cooling temperature; the ambient temperature of the vehicle is higher than the second threshold ambient temperature; and the temperature of the coolant discharged from the first pump 41 is higher than the first threshold coolant temperature. For example, the second required cooling temperature may be 36° C., the second threshold ambient temperature may be 40° C., and the first threshold coolant temperature may be 45° C.

The vehicle thermal management system in the third mode may meet the following control conditions (heating conditions of the refrigerant system 60): the heating of the cabin is required; the maximum temperature of the battery 11 is lower than a first operating temperature; and the temperature of the coolant discharged from the first pump 41 is higher than a second threshold coolant temperature. The second threshold coolant temperature may be lower than the first threshold coolant temperature. For example, the first operating temperature may be 5° C.), and the second threshold coolant temperature may be 0° C.).

FIG. 5 illustrates a state in which the vehicle thermal management system according to an embodiment of the present disclosure operates in a fourth mode. Referring to FIG. 5, when the vehicle thermal management system operates in the fourth mode, the coolant cooled by the radiator 13 may cool the PE component 12, and the refrigerant system 60 may operate in a heating mode using the waste heat of the battery 11 and the waste heat of the HPC 14 or operate in a cooling mode to allow the coolant cooled by the chiller 15 to cool the HPC 14 and the battery 11.

Referring to FIG. 5, the control valve 30 may fluidly connect the second port 32 and the third port 33 so that the coolant cooled by the radiator 13 may pass through the coolant passage of the PE component 12 by the second pump 42, and the PE component 12 may be cooled by the coolant.

Referring to FIG. 5, the control valve 30 may fluidly connect the first port 31 and the fifth port 35 and close the fourth port 34, and the distribution valve 50 may fluidly connect the inlet port 51 to the first outlet port 52 and the second outlet port 53 so that the coolant discharged from the first port 31 of the control valve 30 may be distributed to the coolant passage of the battery 11 and the coolant passage of the HPC 14 through the first outlet port 52 and the second outlet port 53 of the distribution valve 50, and then pass through the coolant passage 15a of the chiller 15.

When the heating of the cabin is required, the coolant heated by the waste heat of the battery 11 and the waste heat of the HPC 14 may pass through the coolant passage 15a of the chiller 15, and the coolant passing through the coolant passage 15a of the chiller 15 may release heat to the refrigerant passing through the refrigerant passage 15b of the chiller 15 so that the refrigerant system 60 may absorb the waste heat of the battery 11 and the waste heat of the HPC 14 through the chiller 15, and the refrigerant system 60 may operate in the heating mode.

When the cooling of the cabin is required, the refrigerant system 60 may operate in the cooling mode. As the refrigerant system 60 operates in the cooling mode, the coolant passing through the coolant passage 15a of the chiller 15 may release heat to the refrigerant passing through the refrigerant passage 15b of the chiller 15 so that the coolant may be cooled by the chiller 15, and the coolant cooled by the chiller 15 may cool the battery 11 and the HPC 14.

The vehicle thermal management system in the fourth mode may meet the following control condition (cooling condition of the PE component 12, the battery 11, and the HPC 14): the maximum temperature of the battery 11 is higher than the second required cooling temperature. For example, the second required cooling temperature may be 36° C.

The vehicle thermal management system in the fourth mode may meet the following control conditions (heating conditions of the refrigerant system 60): the heating of the cabin is required; the maximum temperature of the battery 11 is higher than the first required cooling temperature; and the temperature of the coolant discharged from the first pump 41 is higher than the second threshold coolant temperature. The second threshold coolant temperature may be lower than the first threshold coolant temperature. For example, the first required cooling temperature may be 30° C., and the second threshold coolant temperature may be 0° C.

In the fourth mode, the distribution valve 50 may adjust a ratio between the opening degree of the first outlet port 52 and the opening degree of the second outlet port 53 based on the temperature of the coolant discharged from the first pump 41, thereby determining a distribution ratio of the coolant flowing into the battery 11 and the HPC 14. For example, when the temperature of the coolant is lower than 25° C., the ratio of the coolant flowing into the coolant passage of the battery 11 and the coolant flowing into the coolant passage of the HPC 14 may be 90% and 10%. When the temperature of the coolant is higher than 25° C. and lower than 32° C., the ratio of the coolant flowing into the coolant passage of the battery 11 and the coolant flowing into the coolant passage of the HPC 14 may be 70% and 30%. When the temperature of the coolant is higher than 32% and lower than 40° C., the ratio of the coolant flowing into the coolant passage of the battery 11 and the coolant flowing into the coolant passage of the HPC 14 may be 50% and 50%. When the temperature of the coolant is higher than 40° C., the ratio of the coolant flowing into the coolant passage of the battery 11 and the coolant flowing into the coolant passage of the HPC 14 may be 50% and 50%, and the distribution valve 50 may be controlled in cooperation with the refrigerant system 60.

FIG. 6 illustrates a state in which the vehicle thermal management system according to an embodiment of the present disclosure operates in a fifth mode. Referring to FIG. 6, when the vehicle thermal management system operates in the fifth mode, the refrigerant system 60 may operate in a heating mode using the waste heat of the PE component 12, and the battery 11 may be warmed up using the waste heat of the HPC 14.

Referring to FIG. 6, the control valve 30 may fluidly connect the second port 32 and the fifth port 35 and close the third port 33 so that the coolant heated by the waste heat of the PE component 12 may pass through the coolant passage 15a of the chiller 15, and the coolant passing through the coolant passage 15a of the chiller 15 may release heat to the refrigerant passing through the refrigerant passage 15b of the chiller 15 so that the refrigerant system 60 may operate in the heating mode.

Referring to FIG. 6, the control valve 30 may fluidly connect the first port 31 and the fourth port 34, and the distribution valve 50 may fluidly connect the inlet port 51 to the first outlet port 52 and the second outlet port 53 so that the coolant discharged from the first port 31 of the control valve 30 may be distributed to the coolant passage of the battery 11 and the coolant passage of the HPC 14 through the first outlet port 52 and the second outlet port 53 of the distribution valve 50, and then be directed to the fourth port 34 of the control valve 30. The battery 11 may be warmed up by the waste heat of the HPC 14.

The vehicle thermal management system in the fifth mode may meet the following control conditions: the heating of the cabin is required; the maximum temperature of the battery 11 is lower than the first operating temperature; and the temperature of the coolant discharged from the first pump 41 is higher than a third threshold coolant temperature. The third threshold coolant temperature may be lower than the first threshold coolant temperature and be higher than the second threshold coolant temperature. For example, the first operating temperature may be 5° C., and the third threshold coolant temperature may be 10° C.).

FIG. 7 illustrates a state in which the vehicle thermal management system according to an embodiment of the present disclosure operates in a sixth mode. Referring to FIG. 7, when the vehicle thermal management system operates in the sixth mode, the refrigerant system 60 may operate in a heating mode using the waste heat of the PE component 12, and the battery 11 may be warmed up by the battery warmer 16.

Referring to FIG. 7, the control valve 30 may fluidly connect the second port 32 and the fifth port 35 and close the third port 33 so that the coolant heated by the waste heat of the PE component 12 may pass through the coolant passage 15a of the chiller 15, and the coolant passing through the coolant passage 15a of the chiller 15 may release heat to the refrigerant passing through the refrigerant passage 15b of the chiller 15 so that the refrigerant system 60 may operate in the heating mode.

Referring to FIG. 7, the control valve 30 may fluidly connect the first port 31 and the fourth port 34, and the distribution valve 50 may fluidly connect the inlet port 51 and the first outlet port 52 so that the coolant discharged from the first port 31 of the control valve 30 may pass through the coolant passage of the battery 11 and the coolant passage of the battery warmer 16 through the first outlet port 52 of the distribution valve 50. Here, as the battery warmer 16 is turned on, the coolant may be heated by the battery warmer 16, and the coolant heated by the battery warmer 16 may warm up the battery 11.

The vehicle thermal management system in the sixth mode may meet the following control conditions: the heating of the cabin is required; the maximum temperature of the battery 11 is lower than a second operating temperature; and the temperature of the HPC 14 is lower than the temperature of the coolant discharged from the first pump 41. The second operating temperature may be higher than the first operating temperature. For example, the second operating temperature may be 15° C.

As set forth above, the vehicle thermal management system according to embodiments of the present disclosure may be designed to efficiently perform the thermal management of the HPC, the thermal management of the battery, and the thermal management of the PE component.

According to embodiments of the present disclosure, the HPC and the battery may be connected in parallel to the control valve so that the thermal management of the HPC and the thermal management of the battery may be performed independently of each other. Accordingly, the operation of the refrigerant system and the operation of the chiller may be optimized, and thus the electric efficiency of the vehicle may be improved.

According to embodiments of the present disclosure, the HPC may be cooled independently of the battery, and the HPC may be selectively cooled by the radiator or the refrigerant system. Thus, the electric efficiency of the vehicle may be improved, and the thermal management of the HPC may be performed more efficiently compared to the vehicle thermal management system according to the related art.

According to embodiments of the present disclosure, the refrigerant system may absorb the waste heat of the HPC so that heating efficiency of the refrigerant system may be improved. Thus, all electric range (AER) of the vehicle may be increased.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A vehicle thermal management system, comprising:
a control valve;
a battery fluidly connected to the control valve;
a power electronics (PE) component fluidly connected to the control valve;
a radiator fluidly connected to the control valve; and
a high-performance computer (HPC) fluidly connected to the control valve,
wherein the HPC and the battery are connected in parallel to the control valve, and
the control valve is configured to control a flow of a coolant between the PE component, the radiator, the battery, and the HPC.

2. The vehicle thermal management system according to claim 1, wherein the control valve includes:
a first port fluidly communicating with an inlet of the battery and an inlet of the HPC,
a second port fluidly communicating with an inlet of the PE component,
a third port fluidly communicating with an inlet of the radiator, and
a fourth port fluidly communicating with an outlet of the battery and an outlet of the HPC.

3. The vehicle thermal management system according to claim 2, further comprising a chiller thermally connected to a refrigerant system,
wherein the control valve further includes a fifth port communicating with the chiller.

4. The vehicle thermal management system according to claim 3, wherein the battery and the HPC are connected in parallel to the chiller.

5. The vehicle thermal management system according to claim 3, wherein the radiator and the PE component are connected in parallel to the chiller.

6. The vehicle thermal management system according to claim 3, wherein the control valve is configured to fluidly connect the first port to at least one of the third port, the fourth port, or the fifth port.

7. The vehicle thermal management system according to claim 6, wherein the control valve is configured to fluidly connect the second port to at least one of the third port, the fourth port, or the fifth port.

8. The vehicle thermal management system according to claim 3, wherein the chiller includes: a refrigerant passage through which a refrigerant passes, and a coolant passage through which the coolant passes, and
the chiller includes a first port, a second port, and a third port communicating with the coolant passage.

9. The vehicle thermal management system according to claim 6, wherein the chiller includes:
a first port communicating with the outlet of the battery and the outlet of the HPC,
a second port communicating with an outlet of the PE component and an outlet of the radiator, and
a third port fluidly communicating with the fifth port of the control valve.

10. The vehicle thermal management system according to claim 2, further comprising a distribution valve configured to control the flow of the coolant into at least one of the battery or the HPC.

11. The vehicle thermal management system according to claim 10, wherein the distribution valve includes:
an inlet port fluidly communicating with the first port of the control valve,
a first outlet port fluidly communicating with the inlet of the battery, and
a second outlet port fluidly communicating with the inlet of the HPC.

12. The vehicle thermal management system according to claim 2, further comprising a first pump fluidly communicating with the first port of the control valve.

13. The vehicle thermal management system according to claim 2, further comprising a second pump fluidly communicating with the second port of the control valve.

14. The vehicle thermal management system according to claim 1, further comprising a battery warmer fluidly connected to the battery.

15. The vehicle thermal management system according to claim 1, further comprising a reservoir tank fluidly connected to the radiator.
